(19) United States
(12) Patent Application Publication
(10) Pub. No.: US 2023/0041337 A1
(43) Pub. Date: Feb. 9, 2023

(54) MULTI-NEURAL NETWORK ARCHITECTURE AND METHODS OF TRAINING AND OPERATING NETWORKS ACCORDING TO SAID ARCHITECTURE

(71) Applicant: Istanbul Teknik Universitesi, Istanbul (TR)

(72) Inventors: Mustafa ALTUN, Istanbul (TR); Sadra RAHIMI KARI, Istanbul (TR)

(73) Assignee: Istanbul Teknik Universitesi, Istanbul (TR)

(21) Appl. No.: 17/396,822

(22) Filed: Aug. 9, 2021

(51) Int. Cl. G06N 3/04

(52) U.S. Cl. CPC G06N 3/0454

(57) ABSTRACT

A multi-neural network (MNN) architecture and methods for training and operating networks according to the MNN architecture are provided. A multi-neural network includes a plurality of small primary neural networks arranged in parallel, at least one auxiliary neural network and a decision unit, wherein the at least one auxiliary neural network is trained specifically on erroneous data produced by the plurality of small primary neural networks.

### TECHNICAL FIELD

The invention is related to the field of machine learning and specifically to a multi-neural network (MNN) architecture and methods for training and operating networks according to said architecture.

### BACKGROUND

Artificial neural networks comprising nodes analogous to neurons have found use in machine learning schemes. Developments in the design and optimization of such neural networks and their operation have been targeted to increase performance and accuracy in machine learning applications. However, developments in hardware capabilities have been a more significant driver of increased accuracy, thus in turn increasing energy consumption and a stagnation in terms of a more flexible use of hardware.

Methods to improve neural network accuracy generally employ larger or more complex networks and training with larger data sets, resulting in an increase in computational costs. Methods to employ multiple neural networks instead, have also been proposed.

The document numbered U.S. Pat. No. 6,161,196A discloses a method in which multiple copies of a program are executed parallelly. When a fault is detected in a copy, that copy an be operated using a checkpoint obtained from an unfaulty copy.

The document numbered U.S. Ser. No. 10/909,456B2 discloses a method in which multiple neural networks each comprising a different number of nodes are trained to identify features in a data set to achieve different accuracies.

The document numbered U.S. Pat. No. 9,619,748B1 discloses a method in which multiple nonidentical neural networks arranged sequentially. The neural networks can vary from each other by their architectures, interconnections between layers, algorithms, training methods.

The document numbered U.S. Pat. No. 7,472,097B1 discloses a method for employee selection using multiple coupled neural networks.

The document numbered U.S. Ser. No. 10/885,470B2 discloses a method in which penalty terms with different weights are back propagated to members of an ensemble in accordance with errors. The penalty terms are back propagated in way to increase differences in ensembles.

The document numbered US2019180176A1 discloses a method in which a first subnetwork is trained on a dataset, generating error values of the output and using the error values to modify a second subnetwork by backpropagation.

Mashhadi, Nowaczyk ye Pashami (Peyman Sheikholharam Mashhadi, Slawomir Nowaczyk, Sepideh Pashami, Parallel orthogonal deep neural network, Neural Networks, Volume 140, 2021, Pages 167-183, ISSN 0893-6080, https://doi.org/10.1016/j.neunet.2021.03.002.), propose a parallel orthogonal neural network architecture to provide diversity by employing Gram-Schmidt orthogonalization.

### SUMMARY

The aim of the invention is to provide a multi-neural network architecture and methods for training and operating networks according said architecture. The invention allows using a relatively small number of artificial neurons to be trained and operated with reduced error, resulting in lower system requirements and energy consumption, faster training and operation as well as higher accuracy compared to systems employing conventional neural network architectures.

A multi-neural network according to the invention comprises a plurality of relatively small primary neural networks arranged in parallel, at least one auxiliary network and a decision unit.

The method of training the multi-neural network comprises the steps of, processing an input data set with each primary neural network to produce a result data set for each primary neural network; determining the erroneous results in each result data set to produce an error set; processing the error set with the auxiliary neural network.

The method of operating the multi-neural network which has been trained in accordance with the method of training, comprises the steps of, processing an input data set with each primary neural network and the auxiliary network to produce a result data set for each neural network; electing result elements corresponding to elements of the input data set based on the output of the primary neural networks and the auxiliary neural network.

### DETAILED DESCRIPTION OF THE EMBODIMENTS

A multi-neural network according to the invention comprises a plurality of primary neural networks, at least one auxiliary neural network and a decision unit.

The primary neural networks and the auxiliary neural network each consist of an input layer, an output layer and at least one intermediate layer arranged between the relevant input layer and output layer. Each layer is constructed with a plurality of artificial neurons connected to the artificial neurons of the preceding and the succeeding layers.

The primary neural networks are arranged to work in parallel, that is, they receive and process the same input data set and they each produce a result data set corresponding to the input data set. The input data set is essentially in the form of a list of elements to each of which a result is to be produced. Said result may be an identifier regarding the element, a response to the element, an estimate of the evolution of the element or another quantifier related to and deriving from the element.

The input data set can be in the form of a list with more than one dimensions. The result data sets produced by each primary neural network are preferably arranged in the form of a list having a similar structure as that of the input data set. Instead of a plurality of result data sets, a single result data set with the results from different primary neural networks arranged to be differentiable from each other can be employed.

During training of the multi-neural network, the primary neural networks are fed an input data set having a corresponding correct result data set that is composed of pre-evaluated elements corresponding to each element of the input data set. The result data sets of produced by the primary neural networks are then compared to the correct result data set to determine the erroneous results. An error set is composed using these erroneous results. The error set comprises the erroneous results along with identifiers corresponding to primary neural networks and indices corresponding to each erroneous result. The auxiliary neural network is then trained using the error set. Being trained on a set limited to the erroneous results of the primary neural networks, the auxiliary neural network has a higher probability of predicting the correct output than the primary neural networks.

During regular operation of the multi-neural network, the auxiliary neural network is also arranged to work in parallel to the primary neural networks. The input data set is simultaneously fed to the primary neural networks and the auxiliary neural network. After processing by the primary neural networks and the auxiliary neural network, the results are interpreted by the decision unit. Using the results from all neural networks, the decision unit elects a single result element corresponding to each element of the input data set.

While the input data set is preferably as large as feasible during training, an input data set with a single member can be processed during operation of the multi-neural network.

In one embodiment of the invention, the decision unit elects result elements by ordering the results of the primary networks according to the count of matching result elements. Matching result elements can be determined to be the result elements having the same value or having a separation within a threshold value. If two or more results have the highest count, the decision is based on the output of the auxiliary neural network. If there are not any two results with the highest count, the result with the highest count is chosen. The elected result elements thus make up the output of the multi-neural network.

In a preferred embodiment of the invention, in order to provide the highest performance, the multi-neural network is constructed with a variety of primary neural networks, thus making use of complementing sets. The variation in primary neural networks can be introduced by at least one of employing primary neural networks having different internal topologies, employing different probability density functions to generate initial random weights, checking for and removing similarities between the initial random weights, employing different training algorithms.

In order to increase variation by generating different random weights for every primary neural network, different probability density functions are used. The probability density functions can be chosen from among those satisfying a normal distribution, an exponential distribution, a universal exponential distribution, an inverse Gaussian distribution, a sparse random distribution or another distribution.

In order to increase variation by checking for and removing similarities between the initial weights, the initial wight matrices of the primary networks can be compared to each other term by term. Whenever weights having similar values are discovered, one of the weights is changed in accordance with the probability distribution function of the relevant primary neural network.

In order to increase variation by employing different training algorithms for different primary neural networks, training algorithms can be chosen from among Newton, quasi-Newton, Levenberg, brute force, random search, stochastic gradient descent or another algorithm.

In an exemplary embodiment of the invention, multiple multi-neural networks according to the invention were trained with an input data set containing the 60000 pieces of data of handwritten digits that form the MNIST database. The error set used for training the auxiliary neural network is therefore constructed from the result data sets corresponding to these 60000 pieces of data. Following training, the multi-neural network was then tested using a set of 10000 pieces of data of handwritten digits.

A control neural network of the multilayer perceptron type having one input layer, two hidden layers with 80 and 60 neurons each and an output layer with 10 neurons was constructed. After training, the control neural network reached 97% accuracy on the test data.

Multi-neural networks were constructed using primary neural networks and auxiliary neural networks having a similar structure with the control neural network. Tests were conducted with multi-neural networks having 2, 3, 4 and 5 primary neural networks and one auxiliary neural network. With 3 primary neural networks with different distribution functions, an accuracy or 99.19% was achieved. With 5 primary neural networks trained by different algorithms, an accuracy of 99.56% was achieved.

Neural network types other than multilayer perceptrons, such as convolutional neural networks, recurrent neural networks and deep networks, can be employed for constructing multi-neural networks according to the invention.

A multi-neural network according to the invention can be generated, trained and operated on a computer system having at least one processor for executing program instructions and at least one memory device for storing program instructions. The computer system can be comprised of a single unit or multiple units working in connection to each other.

What is claimed is:

1. A method of training a multi-neural network, comprising the following steps:
providing a plurality of primary neural networks and at least one auxiliary neural network,
processing an input data set with each primary neural network to produce a result data set for the each primary neural network,
determining erroneous results in each result data set to produce an error set,
processing the error set with the at least one auxiliary neural network.

2. The method of claim 1, wherein the erroneous results are determined by comparing the result data set with a correct result data set, wherein the correct result data set is composed of pre-evaluated elements corresponding to each element of the input data set.

3. A method of operating a multi-neural network, wherein the multi-neural network is trained by the following steps;
providing a plurality of primary neural networks and at least one auxiliary neural network,
processing an input data set with each primary neural network to produce a result data set for each primary neural network,
determining erroneous results in each result data set to produce an error set,
processing the error set with the at least one auxiliary neural network,
the method comprises the following steps:
processing the input data set with the each primary neural network and the at least one auxiliary neural network to produce a result data set for each primary neural network and the at least one auxiliary neural network,
electing result elements corresponding to elements of the input data set based on an output of the plurality of primary neural networks and an output of the at least one auxiliary neural network.

4. The method of claim 3, wherein the result elements are elected by the following steps:
ordering results of the plurality of primary neural networks according to a count of matching result elements,
if two or more results have a highest count, a decision is based on the output of the at least one auxiliary neural network,
if no two results with the highest count exist, a result with the highest count is chosen.

5. The method of claim 3, wherein different random weights for the each primary neural network are generated by using different probability density functions.

6. The method of claim 3, wherein initial wight matrices of the plurality of primary neural networks are compared to each other term by term, and whenever weights having similar values are discovered, one of the weights is changed.

7. The method of claim 3, wherein different training algorithms are employed for different primary neural networks.
